(19) United States
(12) Patent Application Publication
(10) Pub. No.: US 2026/0329970 A1
(43) Pub. Date: Oct. 22, 2026

(54) DETECTING AND IDENTIFYING SOURCE DRIFT IN FUSED DATA

(71) Applicant: Dell Products L.P., Round Rock, TX (US)

(72) Inventors: Marcus Vinicius Libardi Pazini, Caxias do Sul (BR); Herberth Birck Fröhlich, Cerro Largo (BR); Luiz Fernando Sommaggio Coletta, Tupã (BR)

(21) Appl. No.: 19/186,494

(22) Filed: Apr. 22, 2025

(51) Int. Cl. G06F 18/2113; G06N 3/0455

(52) U.S. Cl. CPC G06F 18/2113; G06N 3/0455

(57) ABSTRACT

One example method for detecting and identifying source data in fused data includes receiving, from an edge system, a new primal data point in a form of a reduced vector, the reduced vector comprising fused concatenated data obtained from a primal source vector, comparing the new primal data point with a previously obtained data base of encoded datapoints, when, as a result of the comparing, drift is detected in the new primal data point, comparing one or more of those dimensions, of the new primal data point, that have drifted most relative to an established threshold, with an importance table that comprises respective values for features of the new primal data point, and when it is determined that the dimensions of the new primal data point with the most drift align with important features of a decoder, concluding that there is drift in the primal source vector.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to fused data. More particularly, at least some embodiments relate to systems, hardware, software, computer-readable media, and methods for detecting and identifying source drift in fused data.

### BACKGROUND

Data fusion (DF) techniques include diverse methods designed to, essentially, fuse raw data, features and even decisions from multiple domains or sources into a single data source/signal. The process of fusing multiple data sources into a single better and more concise postprocessed source allows for significant savings. When DF algorithms are applied in edge environments, the volume of data transferred from edge to cloud significantly decreases while the quality of information remains unaltered. Also, fused datasets have been shown to increase performance/accuracy of smaller AI (Artificial Intelligence) models by providing them more succinct and consistent inputs.

As much as DF techniques help in lowering the volume of data, such as in transfers between cloud and edge environments, some problems remain unsolved. As an example, if one of the data sources fused by the DF algorithm presents some type of abnormality, such as a sensor malfunction for example, abnormal noise from an outside source or even an unexpected change in behavior of the object being inspected, it will cause feature drift within the fused features. Feature drift can drastically affect the quality of output in ML (machine learning) models, and it is a challenge to identify which sensor is causing this unexpected change in the fused feature-space.

One naïve approach for solving this problem is applying standard drift detection methods in each data source before fusing them. A subject matter expert (SME) can decide how to proceed whenever a drift is detected. However, such a solution presents a scaling problem, namely, managing the drift detection across multiple sensors can be overwhelming, especially if the number of sensors increases, as performing drift detection individually for each new data source adds more computational burden to the edge layer.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a basic autoencoder architecture.

FIG. 2 discloses an example of SHAP values for housing prices.

FIG. 3 discloses aspects of a method, according to one embodiment.

FIG. 4 discloses an approach for training an encoder E₀, according to one embodiment.

FIG. 5 discloses an approach for constructing a reduced database, according to one embodiment.

FIG. 6 discloses an approach for training decoders, according to one embodiment.

FIG. 7 discloses an approach for feature ranking through SHAP, according to one embodiment.

FIG. 8 discloses examples of eCDFs and p-value.

FIG. 9 discloses an approach for training of models and importance table construction, according to one embodiment.

FIG. 10 discloses an operational sequence of operations to identify drift in sources from fused data, according to one embodiment.

FIG. 11 discloses an example computing entity configured and operable to perform any of the disclosed methods, processes, and operations.

### DETAILED DESCRIPTION OF SOME EXAMPLE EMBODIMENTS

Embodiments disclosed herein generally relate to fused data. More particularly, at least some embodiments relate to systems, hardware, software, computer-readable media, and methods for detecting and identifying source drift in fused data.

One or more embodiments comprise methods and architectures for detecting and identifying source drift in fused data. One embodiment comprises a method that determines which data source, of a group of data sources that contribute data to a fused dataset, is responsible for the drift observed in the already fused dataset. A method according to one embodiment may eliminate, for example, the need to analyze individual sources of raw data, store unfused data, send raw data to the cloud, and add more computational processes to edge nodes. One embodiment may combine an autoencoder-like architecture together with explainable AI (XAI) techniques to create a method capable of identifying the source of drift directly in the vector belonging to the fused-space. This method does not need to access the original data, nor the source(s) of that original data.

A method according to one embodiment may comprise various operations including, but not limited to: acquiring data from the instrumented asset such as a sensor, IoT device, or autonomous device/system; concatenating the data into a new primal source vector [symbol] of length M; fusing the concatenated data into a reduced vector z_{T+1} and sending the concatenated data to a cloud environment; in the cloud environment analyzing the new data point, that is, the reduced vector z_{T+1} and comparing the new data point with a previously obtained data base of encoded datapoints [symbol] ; when drift is detected in the dimensions of z_{T+1}, comparing the most drifted dimensions with an importance table that was created with the values; and, after comparing the drift with the table, and when it has been determined that the dimensions of z_{T+1} with most drift align with the most important features of the decoder D₁, concluding that there is drift in the primal source s₁.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that data sources causing drift in fused data, comprising data from the data sources, can be detected. An embodiment may be able to detect drift in fused data even when there is no access, at an edge environment or elsewhere, to the previous unfused or reconstructed data that was used to form the fused data. directly at the edge. Various other advantages of one or more example embodiments will be apparent from this disclosure.

### A. REFERENCES

Reference is made herein to various documents, which are listed below. These documents are all incorporated herein by this reference.
[1] A. Munir, E. Blasch, J. Kong, J. Kwon and A. Aved, “Artificial Intelligence and Data Fusion at the Edge,” IEEE A&E SYSTEMS MAGAZINE, pp. 62-78, 2021.
[2] A. Bifet and R. Gavalda, “, Learning from time changing data with adaptive windowing, in: Proceedings of the 2007 SIAM,” changing data with adaptive windowing, in: Proceedings of the 2007, pp. 443-448, 2007.
[3] X. WANG, Q. KANG, J. AN and M. ZHOU, “Drifted Twitter Spam Classification Using Multiscale Detection Test on K-L Divergence,” IEEE Access, vol. 7, pp. 108384-108394, 2019.
[4] B. Eck, D. Kabakci-Zorlu and A. Ba, “Two-sample KS test with approxQuantile in Apache Spark®,” IEEE International Conference on Big Data, pp. 1912-1917, 2023.
[5] K. Roshan and A. Zafar, “UTILIZING XAI TECHNIQUE TO IMPROVE AUTOENCODER BASED MODEL FOR COMPUTER NETWORK ANOMALY DETECTION WITH SHAPLEY ADDITIVE EXPLANATION (SHAP),” International Journal of Computer Networks & Communications (IJCNC), November 2021.
[6] L. Antwarg, M. M. Miller, B. Shapira and L. Rokach, “Explaining Anomalies Detected by Autoencoders Using SHAP,” Journal of Artificial intelligence, 2020.
[7] S. Lundberg, “An introduction to explainable AI with Shapley values,” 2018. [Online].
[8] A. Ceffer and J. Levendovszky, “Kolmogorov-Smirnov Test for Keystroke Dynamics Based User Authentication,” IEEE International Symposium on Computational Intelligence and Informatics, pp. 17-19, 17 Nov. 2016.
[9] P. Sidhu and A. Bindal, “Empirical support for Weighted Majority, Early Drift Detection Method and Dynamic Weighted Majority,” International Conference on Machine Intelligence Research and Advancement, pp. 623-627, 2013.

### B. ASPECTS OF AN EXAMPLE OPERATING CONTEXT FOR ONE OR MORE EMBODIMENTS

The following is a discussion of aspects of example contexts for various embodiments. This discussion is not intended to limit the scope of the claims or this disclosure, or the applicability of the embodiments, in any way. Particularly, the following sections provide information useful for the comprehension of various concepts implemented by one or more embodiments.

### B.1 Drift in Data Sources

As used herein, ‘data drift’ refers to changes in the statistical properties of a dataset over time. When these changes happen, a ML model trained using data from the previous distribution can become outdated and less accurate. As a result, the model may turn from an asset into a liability.

A similar difficulty occurs in the context of DF. As DF fuses multiple data sources into one, data drift is an eminent threat for the resulting data representation. In more detail, if any of the sources experience a distribution shift, the quality of the fused data can be severely impacted, so that all the models that rely on that fused data can become unsuitable for the task they address.

Some methods for drift detection are based on the comparison of windowed data distributions to find changes whenever new data arrive. Below are some typical approaches for drift detection:
1. Adaptive Sliding Window (ADWIN): Maintains a variable-length window of recent data and detects drift by comparing statistics from different parts of the window. See [2].
2. Kullback-Leibler (KL) Divergence: Measures how a given data distribution diverges from another taking into account their probabilities. See [3].
3. Kolmogorov-Smirnov (KS) Test: A nonparametric test that compares the distributions of two samples to detect differences. See [4].
   Each of these methods has its pros and cons, and may be used to detect one or more drift types, such as: sudden, incremental, recurrent, and gradual. See [2] and [4].

### B.2 Autoencoders

In machine learning, an autoencoder (AE) is a type of artificial neural network that performs unsupervised learning through two components, namely, [a] an encoder and [b] a decoder. The encoder learns representations of the original data (encoding), while the decoder projects these latent representations back to their original state (decoding).

To better understand how an AE works, suppose that there exists a dataset [symbol] ∈ [symbol] , and this dataset is mapped to an encoded space ( [symbol] ∈ [symbol] ) by the encoder defined as E: [symbol] → [symbol] , with d<n.

Later, the embedded representation of the dataset is reconstructed with the decoder: D: [symbol] → [symbol] , where [symbol] is the best reconstruction of [symbol] learned by the pair encoder/decoder. The weights to perform the embedding and reconstruction are obtained by minimizing a loss function, for example, the mean squared error (MSE) with an optimization method such as stochastic gradient descent (SGD) during the training of the algorithm.

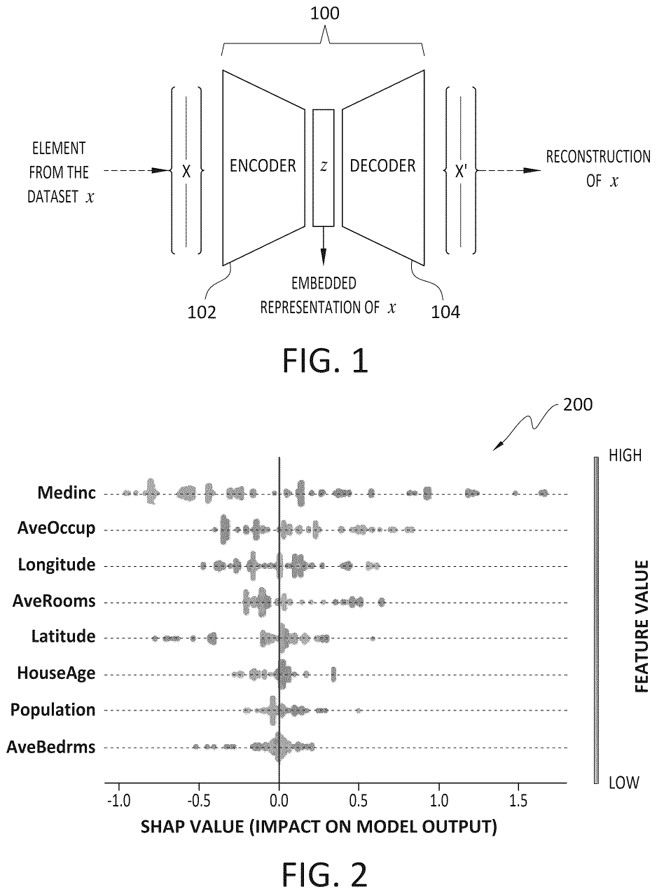

FIG. 1 discloses how, with an autoencoder 100, an element x from the dataset [symbol] is embedded by an encoder 102 into its latent representation z∈ [symbol] and how this latent representation is reconstructed into x′ by a decoder 104.

### B.3 Explainable AI (XAI)

In the context of this disclosure, reference is made to explainable AI (XAI) as a set of methods which enable humans to obtain a greater level of understanding about how a black box machine learning model, such as an autoencoder for example, correlates its inputs with its outputs. In other words, XAI includes methods that, when applied to complex functions, yield information about how this function is calculating its outputs and what is the influence of each input point to the results output by the model. Example embodiments may employ SHapley Additive explanations (SHAP), as it is a model agnostic algorithm that enables the understanding of the respective contribution that each input feature has over the output.

SHAP values may be used to explain model predictions by calculating how much each feature contributes to the model output. For example, suppose a model G is used to calculate values from a domain x to an image y, G:x→y, and x is a vector of multiple dimensions. In this case, SHAP will indicate the extent to which a change in each element of x affects the outcome of the model, y. Intuitively, features with small changes in x that result in large changes in y are more important than elements in x that require greater change in value to make the same impact on a prediction by the model.

In more detail, SHAP calculates the impact of each feature, elements of x in this case, by using a game-theoretic approach based in SHapley values, evaluating each model output with and without each feature across all possible combination of features, and thus determining the marginal contribution of each feature to the prediction. These contributions are then averaged to obtain the SHAP values, which is the feature importance. This makes SHAP a flexible technique capable of being used in several types of models, one of them being autoencoders. See [5] and [6].

The SHAP outcome can be presented visually, such as in a graph 200 as shown in FIG. 2, where a model is utilized to predict housing prices. See [7]. The horizontal axis of the graph 200 indicates the SHAP values for each feature and the vertical axis of the graph 200 indicates the feature importance. Features are ranked top to bottom in order of importance, this ranking can be calculated by different metrics. However, the most common is to take the mean of the absolute value all SHAP values.

For example, consider the “Longitude” variable, representing a geographical location of the house. Whenever this “Longitude” variable decreases, it can be observed that there is a high negative contribution in the output value of the model, while low values of the “Longitude” variable have a high positive contribution, that is, in this dataset, houses located closer to the south tend to be more expensive.

### C. OVERVIEW OF ASPECTS OF AN EMBODIMENT

One way of interpreting DF algorithms is that they are methods to combine multiple raw data sources, henceforth referred to herein as “primal sources/datasets,” by fusing them in a reduced feature vector (z) while retaining and enhancing the outputted information, either in quality or volume. If feature drift happens in z, it is nontrivial to determine which component of the primal source is causing this issue without analyzing the primal dataset directly. Embodiments may comprise methods for solving this nontrivial, which may, in some instances, be considered as comprising the following operations:
1. training an autoencoder (AE), that includes one encoder (E₀) and one decoder (D₀), to fuse the primal dataset into latent vectors z.
2. creating a fused dataset ( [symbol] ) by running E₀ on the primal database for extracting and storing every latent vector ( [symbol] ={z₁, z₂, . . . , z_{N}}).
3. training one decoder Dᵢ for each source of the primal dataset, e.g., if the fusing algorithm fuses signals coming from 10 sensors, we will have 10 decoders (D₁, D₂, . . . , D₁₀). Each one these decoders receive the latent vectors z and output the reconstructed signal from their correspondent sensor in the database.
4. using an XAI algorithm on every decoder to understand which features of z are the most important for the reconstruction of each sensor.
5. detecting if drift is happening in the fused vector z and if so, which of its features are being most affected.
6. when drift is detected, comparing the drifted features with the most important features of each decoder (obtained in 4 above). The source that is presenting drift is the one in which the most important features of the decoder, and the drifting features, are the same.

This approach may provide various benefits, including, but not limited to:
1. Promote great reduction in storage, since maintaining unfused features are no longer necessary to calculate drift.
2. Detecting drifting sources directly from fused features.
3. Eliminating the need of sending unfused data, i.e., large volume of data, from Edge to Cloud only to analyze drift in primal sources.
4. Release the computational burden in edge devices by allowing drift to be detected in fused data that has been sent to a cloud environment.

### D. DETAILED DISCUSSION OF ASPECTS OF ONE OR MORE EMBODIMENTS

Following is a discussion of operations employed by one or more embodiment to find source drift in fused data. An embodiment may assume that a dataset from primal sources ( [symbol] ) is available, and that the elements of this data set are able to be organized in the form of

$$X = \{ [ {x}_{1}^{s 1} , {x}_{2}^{s 1} , … , {x}_{T}^{s 1} ] , [ {x}_{1}^{s 2} , {x}_{2}^{s 2} , … , {x}_{T}^{s 2} ] , … [ {x}_{1}^{s N} , {x}_{2}^{sN} , … , {x}_{T}^{s N} ] \} ,$$

where each x is a measurement from a primal source, s1 through sN are the N primal sources that will be fused by the DF algorithm and 1, . . . , T are the timestamp of the data collection, that is, the vector

$${x}_{t}^{s N}$$

represents the data from the N-th primal source collected in the t-th instant, and the data to be fused are all the data that share the same timestamp,

$$[ {x}_{t}^{s 1} , {x}_{t}^{s 2} , … , {x}_{t}^{s N} ] .$$

### D.1 Methodology Overview of an Embodiment

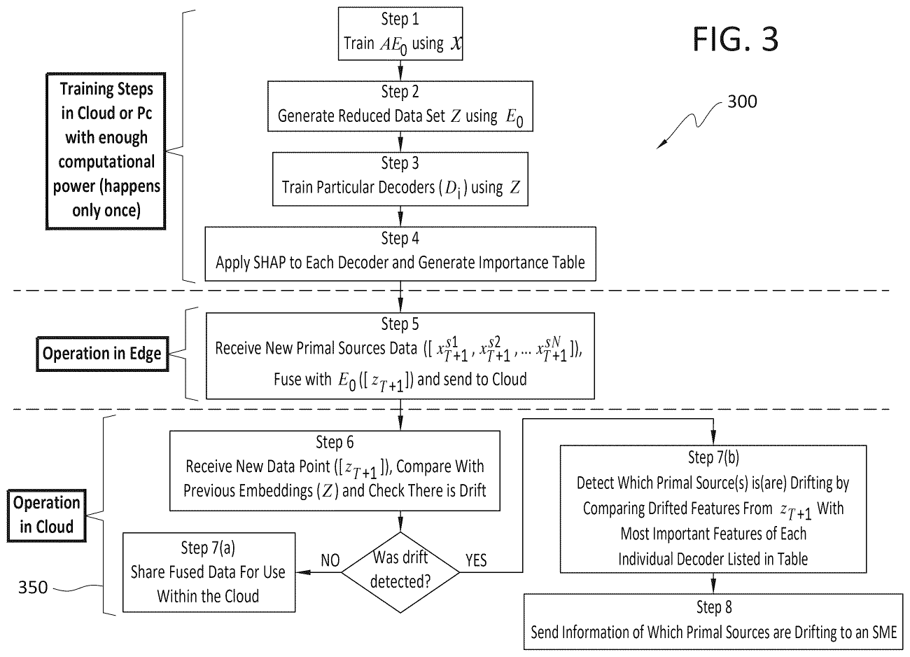

The pipeline of an embodiment, disclosed as a method 300 in FIG. 3, may begin with the training (‘Step 1’) of a global autoencoder (AE₀), which consists of an encoder and decoder pair, respectively E₀ and D₀, as described earlier herein. The input of this autoencoder is all the data from the primal sources ( [symbol] ) that are acquired at an instant t, concatenated into one vector of size M, where M is the sum of the length of every source from the incoming primal data sources, that is, xₜ=concat

$$( {x}_{t}^{s 1} , {x}_{t}^{s 2} , … , {x}_{t}^{s N} ) .$$

With this model trained, the next step is to generate (‘Step 2’) a reduced data set by applying E₀ to the database. This dataset is denoted as [symbol] ={z₁, z₂, . . . , z_{T}}, where zₜ represents the encoding of the concatenated data sources s1 through sN obtained at instant t.

Once [symbol] is created, an embodiment may proceed to train (‘Step 3’) one particular decoder for each of the original primal source signals, thereby generating a set of decoders D={D₁, . . . , D_{N}}, these decoders receive as input the reduced vectors z∈ [symbol] . For example, the decoder D₁ has as inputs all vectors in [symbol] , and its output must be the reconstruction of the primal source s1, formally D₁:

$${z}_{t} \to {x}_{t}^{s 1} .$$

With this set of decoders trained, the next step is to apply (‘Step 4’) the SHAP method, discussed above, to each decoder, and list what are the features in their input z that are the most important. This enables the construction of a table, such as Table 1 below, where each row represents one of the decoders, and each column is the feature of z in order of importance. For example, if z∈ [symbol] , the most important feature of D₁ could be z(3), followed by z(1), and as least important z(2), and its row in Table 1 would be:

TABLE 1

| | First Most | Second Most | Third Most |
|---|---|---|---|
| Decoder | Important Feature | Important Feature | Important Feature |
| D₁ | z(3) | z(1) | z(2) |

At some point after the SHAP method is applied (‘Step 4’), new primal sources data may be received (‘Step 5’) at the edge. This new data may be transmitted to a cloud environment.

The last step in this example approach is to detect if there is a source drift and if so, find out to which primal source the drift is related. To detect source drift, such as in a cloud environment, an embodiment may apply a drift detection method 350 that can compare a new data point that was received (‘Step 6’) with several existing data points, and then determine if this new data point, or entry, is statistically similar to past inputs or not. This comparison may be performed for example, using one of the methods discussed in the ‘Drift In Data Sources’ section above or, alternatively, measuring the adhesion of the new data point to Gaussian Mixture Models (GMM)). If the new data point is not statistically similar to past inputs, it is considered as drift.

If drift is determined by an embodiment to exist in the embedding of the primal sources, an embodiment may then compare every dimension of the new embedding with the existing embeddings in the data set [symbol] . In one embodiment, this comparison can be done by calculating a statistical measurement of how much each feature from the new embedding deviates from its corresponding existing feature in the embedded database. Then, an embodiment may compare the most deviating features with a feature importance table, and estimate which primal source is drifting. For example, if features important to D₁ are drifting, it is probable that the drift is due to abnormal behavior in the primal source s1. Further details concerning the operations disclosed in Figure are discussed below.

D.2 Training a Global Encoder (E₀) and Global Decoder (D₀)

In an embodiment, the encoder E₀ is the model that produces the embeddings from the primal data sources, which will be further used to train the specific decoders, as well as creating the embeddings from new incoming primal data that will be inspected for drift.

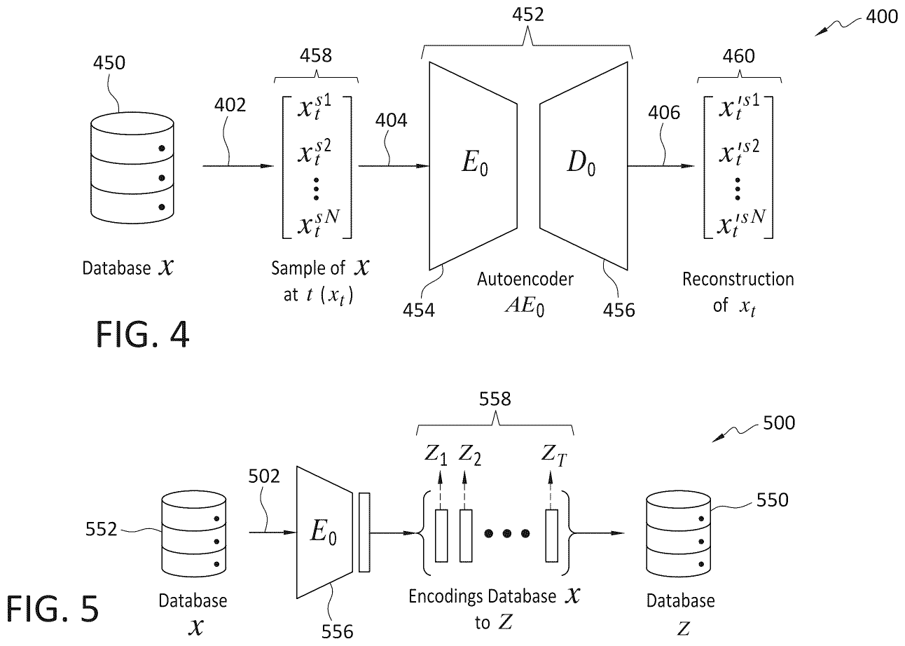

The encoder E₀ is trained with the primal database [symbol] , where each input of the training step is the signal of each primal source at instant t. A pipeline 400, according to one embodiment, for training AE, is shown in FIG. 4, and also described above with reference to the example of FIG. 1.

In more detail, the method 400 may be performed in connection with a database 450 configured to communicate with an autoencoder 452 that comprises an encoder E. 454 and a decoder D₀ 456. A data sample 458 may be obtained 402 from the database 450 and provided 404 to the encoder E, 454 of the autoencoder 452. The decoder D₀ 456 may then output 406 a reconstruction 460 of the input data sample 458.

D.2.1 Using the Encoder E₀ to Create a Latent Database

[symbol]

With reference now to FIG. 5, an example method 500 for constructing a reduced database is disclosed. In the example method 500 of, to create an embedded database Z 550, an embodiment may feed 502 the primal database [symbol] 552 through the encoder E₀ 556, and store the collection of embedded vectors 558 in the embedded database Z 550.

### D.3 Training the Particular Decoders (Dᵢ)

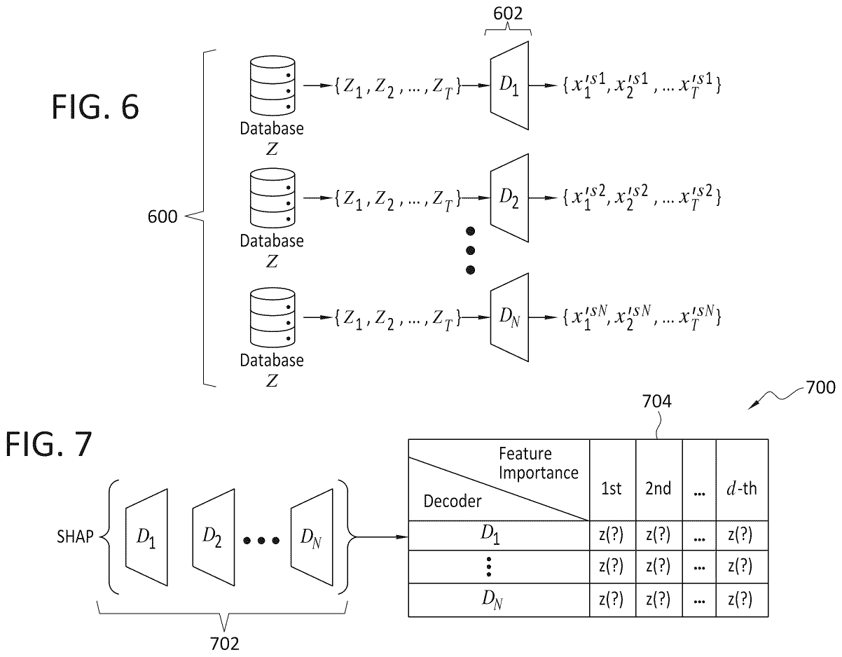

For creating the particular decoders, and with reference now to the example of FIG. 6, the database [symbol] 600 is used to train each of the decoders 602, given that every particular decoder has as features [symbol] , and as a target, their primal source signals, the final weights of the i-th decoder (w_{D}_{ᵢ}) is given by w_{D}_{ᵢ}=argmin( [symbol] (Dᵢ( [symbol] ), [symbol] _{1:T})), where [symbol] is a loss function and [symbol] are the primal signals of the source i.

### D.4 Application of SHAP to Detect Source Drift (Online Stage)

After completion of the training of the decoders, discussed above, which may occur offline in a non-production environment, an embodiment may progress to an online stage. In this online stage, an XAI method, such as SHAP for example, may be used to discover what are the most key features in the embedded space ( [symbol] ), to reconstruct each of sources given a decoder. This information may be later stored on a table and can be searched whenever necessary to discover the relationship of the drifting features with the source signals.

FIG. 7 discloses an example method 700, according to one embodiment, for applying SHAP to each decoder 702, and ranking the most key features in a table 704. In an embodiment, the ranking is performed by calculating the mean value of the magnitude of the SHAP values for each feature, although an SME might decide to use other suitable approaches to attribute ranking of features using the SHAP values.

D.5 Detect Drift in

[symbol]

Attention is directed now to one possible approach, according to one embodiment, for detecting drift in the dimensions of the embedded vector from the primal source. Here, an embodiment may use a statistical measurement to decide if the new incoming embedded data point z_{T+1} belongs to the original distributions of the dimensions of [symbol] . It is important to note that many drift detection methods can be employed in this step, and this choice of method is only an example which helps explain the larger context of an embodiment.

To calculate drift in this case, an embodiment may determine how different each of the dimensions of the new encoded point is with respect to its counterpart in [symbol] . In other words, the aim of an embodiment may be to compare the first dimension of z_{T+1} with the first dimension of each other vector in [symbol] , determining how likely this point belongs to this distribution, and then repeating this process to all other dimensions, that is, if the embeddings belong to [symbol] , an embodiment may compare the d points from z_{T+1} with their respective d collections of points in [symbol] . To make this comparison, two non-limiting examples are given in the following sections.

D.5.1 Comparing a Single Point with [symbol] :Z-Score

A comparison strategy to define drift can be defined by SME, and this strategy may involve checking datapoints individually whenever they arrive in the cloud. One way of testing each dimension of the new point for drift is using the Z-score. In particular, the Z-score is simply a measurement of how many standard deviations a point is from the average of other points in a sample. In one embodiment, the Z-score can be calculated by executing the following operations:
1. Calculate the mean μ and standard deviation σ for every dimension of [symbol] —for example, if the embedded database is in [symbol] , an embodiment will have: (μ₁, σ₁), (μ₂, σ₂) and (μ₃, σ₃).
2. Apply the Z-score formula to determine how many standard deviations the new point (z_{T+1}) is from the mean in each dimension, the following expressions show how to compute this value, where zsₙ is the Z-score in the n-th dimension and z_{T+1}(n) is the n-th position of the vector z_{T+1}.

$${zs}_{1} = \frac{{z}_{T + 1} ( 1 ) - {μ}_{1}}{{σ}_{1}} , {zs}_{2} = \frac{{z}_{T + 1} ( 2 ) - {μ}_{2}}{{σ}_{2}} , {zs}_{1} = \frac{{z}_{T + 1} ( 3 ) - {μ}_{3}}{{σ}_{3}}$$

With the scores calculated, an embodiment may then compare those scores with a threshold defined by an SME, and if any zs value is above, drift is considered as having been detected in that dimension.
D.5.2 Comparing a Sequence of New Points with [symbol] :K-S Test

The KS-test is a statistical test present in libraries such as sci-py and Matlab. Briefly, the KS-Test concerns providing an approach to reject the null hypothesis that a sample A is drawn from a parent distribution B. In this example case, the sample is a buffer of inputs from z_{T+1}, . . . , z_{T+p}, where p is defined by an SME, and the parent distributions come from the previously constructed database [symbol] . Drift occurs if the null hypothesis is rejected.

To find out if the sample A comes from the distribution B, the KS-test uses a distance metric given by the following equation:

Dist_{m,n}=supₓ|F_{A,n}(x)−F_{B,m}(x)|

where the sup is the supremum norm, that is, the maximum absolute value from the element-wise subtraction of the empirical cumulative distribution functions (eCDF) of A and B, namely F_{A,m} and F_{B,m}. These functions are obtained by the following operation:

$${F}_{n} ( t ) = \frac{number of elements in sample \leq t}{n}$$

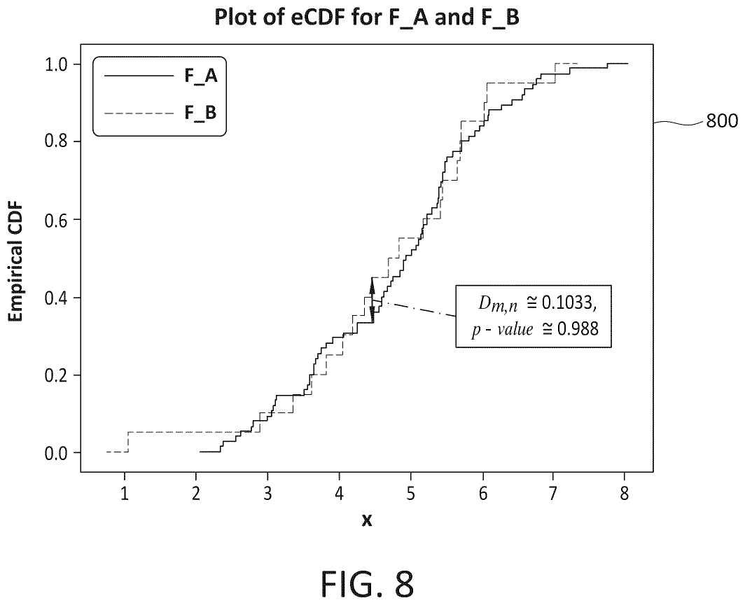

An example of eCDF for two samples from a normal distribution with μ=5 and σ=1.5 is shown in the graph 800 of FIG. 8, which also shows the p-value which indicates that indeed both eCDFs come from the same distributions, while in the case of drift, lower p-values would be observed, with quantities smaller than 0.05 being the most commonly used threshold for rejecting the null hypothesis. For brevity, the p-value calculation steps have been omitted herein, although more details concerning KS-test, how to compute eCDFs, and the p-value, can be found in [8].

### E. ASPECTS OF AN EXAMPLE USE CASE

For one embodiment, consider a use case where an equipment is monitored by a set of three sensors, each one outputting a vector of length m at each instant t, that get data at every time unit t. The data produced by these sensors is then concatenated into a vector of length M to be fused and sent to cloud where drift will be detected. This embodiment assumes that a series of reliable data acquired by this system already exists to train E₀.

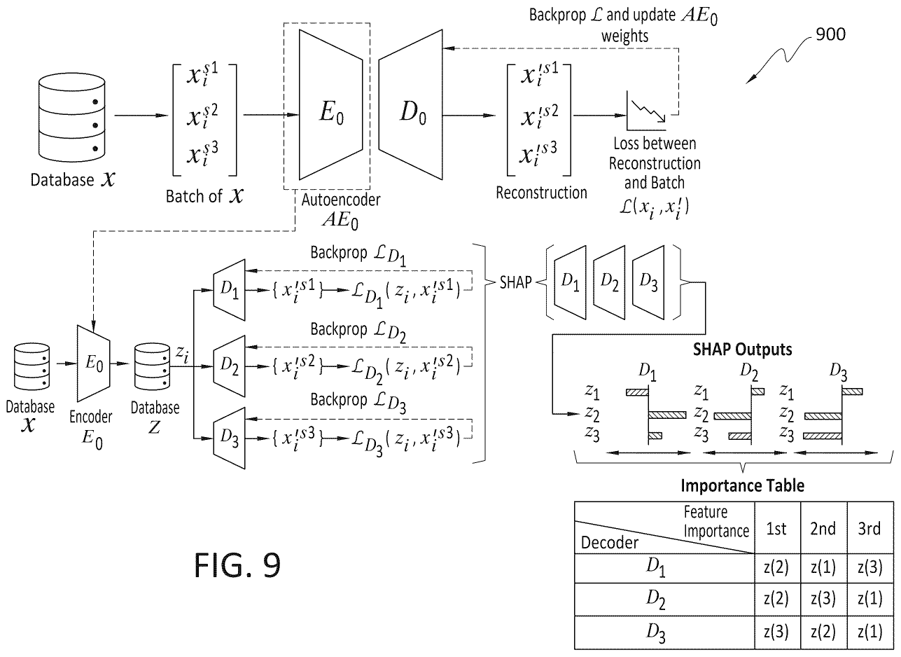

For ease of explanation, reference is made to the encoder E₀ mapping E₀: [symbol] to fuse the sensor data into the representation space [symbol] ∈ [symbol] . However, other embedding sizes can be used in one or more embodiments. FIG. 9 discloses an example method 900 according to one embodiment that comprises operations that may be used to (i) train the encoder E₀, (ii) the particular decoder of each sensor D₁, D₂ and D₃, as well as (iii) the application of SHAP to construct the importance table. As each of these elements (i), (ii) and (iii), is discussed elsewhere herein, reference is made to the other Figures for details concerning the operations disclosed in FIG. 9. That is, the method 900 of FIG. 9 comprises a compilation of various stages of one or more embodiments.

After the execution of the method 900, an embodiment may then proceed to the evaluation of new datapoints to check for source drift. Thus, supposing a new acquisition from the set of sensors is sent to a data fusion pipeline, an embodiment may first concatenate all signals into a long vector of length M. After that, the embodiment may encode the data into an embedded datapoint (z_{T+1}) using E₀ and send the embedded datapoint to a cloud entity or cloud environment. With the fused data in the cloud, an embodiment may then check to if any of the dimensions of z_{T+1} presents drift.

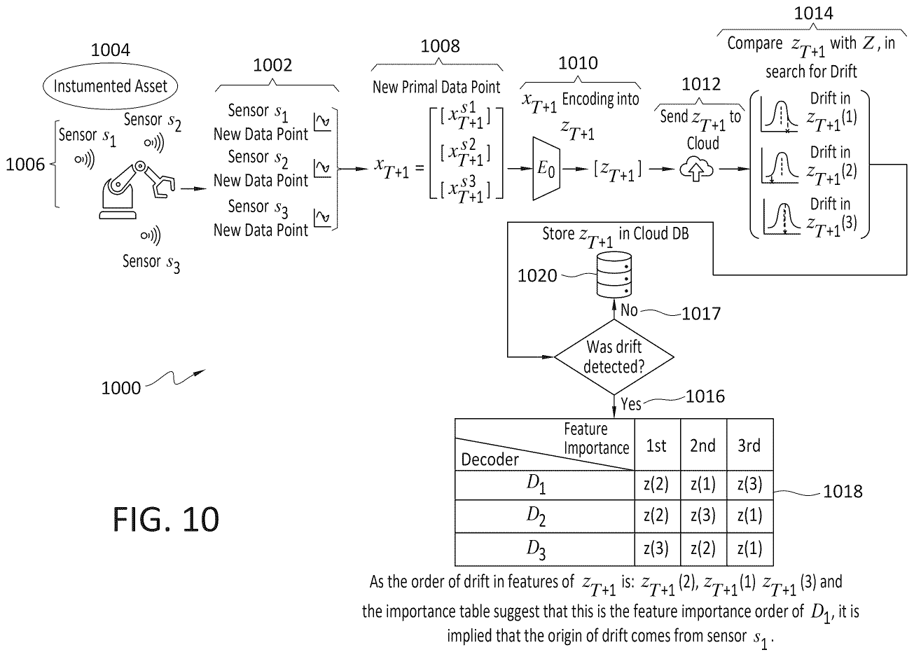

As a hypothesis, consider that an embodiment may calculate drift using a Z-score metric and feature where an SME has set a drift threshold of 0.7. Calculating the drift at each dimension, it can be seen that z_{T+1}(2) presents a drift of 1.6, z_{T+1}(1) presents a drift of 0.9 and z_{T+1}(3) does not present considerable drift as its value was 0.5, which is below the threshold. Then, by inspecting the importance table, it may be concluded that feature 2 is the most important for sensors s₁ and s₂. It may be further observed that the second most drifted feature is z_{T+1}(1), the second in importance for s₁ and only third for s₂, indicating that the drifting source is most likely to be from sensor s₁. FIG. 10 discloses a drift evaluation pipeline 1000 as just described.

In particular, FIG. 10 discloses a schema 1000 comprising an operational sequence of operations to identify drift in sources from fused data. Initially, data 1002 may be acquired from an instrumented asset 1004, such as a device that comprises one or more sensors 1006 that acquire data concerning the operations of the instrumented asset 1004 and/or the environment in which the instrumented asset 1004 operates. The instrumented edge device 1004 may comprise an edge device configured to communicate with a central server and/or other entity at a cloud site.

Next, the data 1002 may concatenated into a new primal source vector 1008, also referred to as a primal data point, [symbol] of length M. The concatenated data 1008 may then be is embedded/fused into a reduced vector z_{T+1} 1010 and sent 1012 to a cloud site.

At the cloud site, the new data point is analyzed and compared 1014 with the previously obtained data base of encoded datapoints [symbol] . If drift is detected 1016 in the dimensions of z_{T+1}, the method may proceed to compare the most drifted dimensions with the importance table 1018 created with the SHAP values. After comparing the drift with the table, it is observed that the dimensions of z_{T+1} with most drift align with the most important features of the decoder D₁, suggesting drift in the primal data source. Note that if drift is not detected 1017, the reduced vector z_{T+1} 1010 may be stored, such as in a cloud database 1020 at the cloud site.

### F. EXAMPLE METHODS

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### G. FURTHER EXAMPLE EMBODIMENTS

Following are some further example embodiments. These are presented only by way of example and are not intended to limit the scope of this disclosure or the claims in any way.

Embodiment 1. A method, comprising: A method for detecting and identifying source data in fused data, comprising: receiving, from an edge system, a new primal data point in a form of a reduced vector, the reduced vector comprising fused concatenated data obtained from a primal source vector; comparing the new primal data point with a previously obtained data base of encoded datapoints; when, as a result of the comparing, drift is detected in the new primal data point, comparing one or more of those dimensions, of the new primal data point, that have drifted most relative to an established threshold, with an importance table that comprises respective values for features of the new primal data point; and, when it is determined that the dimensions of the new primal data point with the most drift align with important features of a decoder, concluding that there is drift in the primal source vector.

Embodiment 2. The method as recited in any preceding embodiment, wherein the edge system comprises an instrumented system that comprises hardware and/or software and includes one or more sensors.

Embodiment 3. The method as recited in any preceding embodiment, wherein the new vector was created by the edge system.

Embodiment 4. The method as recited in any preceding embodiment, wherein a determination that there is drift in the primal source vector is made directly from the fused concatenated data.

Embodiment 5. The method as recited in any preceding embodiment, wherein the importance table comprises a list of decoders, including the decoder, and a respective importance value for specified features, including the specified features of the decoder, of each of the decoders.

Embodiment 6. The method as recited in any preceding embodiment, wherein the reduced vector is created by using an encoder to encode the primal source vector.

Embodiment 7. The method as recited in any preceding embodiment, wherein a message is created and transmitted that identifies which primal source(s) of the primal source vector are drifting.

Embodiment 8. The method as recited in any preceding embodiment, wherein concluding that there is drift in the primal source vector comprises concluding that one or more particular primal sources of the primal source vector are drifting.

Embodiment 9. The method as recited in any preceding embodiment, wherein only fused data is received from the edge system.

Embodiment 10. The method as recited in any preceding embodiment, wherein respective SHAP values indicate a respective importance of each of the features.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### H. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer. By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

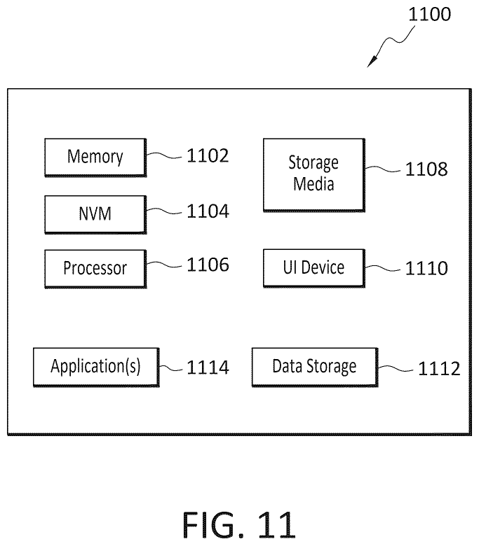

With reference briefly now to FIG. 11, any one or more of the entities disclosed, or implied, by FIGS. 1-10, and/or elsewhere herein, may take the form of, or include, or be implemented on, or hosted by, a physical computing device, one example of which is denoted at 1100. As well, where any of the aforementioned elements comprise or consist of a virtual machine (VM), that VM may constitute a virtualization of any combination of the physical components disclosed in FIG. 11.

In the example of FIG. 11, the physical computing device 1100 includes a memory 1102 which may include one, some, or all, of random access memory (RAM), non-volatile memory (NVM) 1104 such as NVRAM for example, read-only memory (ROM), and persistent memory, one or more hardware processors 1106, non-transitory storage media 1108, UI device 1110, and data storage 1112. One or more of the memory components 1102 of the physical computing device 1100 may take the form of solid state device (SSD) storage. As well, one or more applications 1114 may be provided that comprise instructions executable by one or more hardware processors 1106 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for detecting and identifying source data in fused data, comprising:
receiving, from an edge system, a new primal data point in a form of a reduced vector, the reduced vector comprising fused concatenated data obtained from a primal source vector;
comparing the new primal data point with a previously obtained data base of encoded datapoints;
when, as a result of the comparing, drift is detected in the new primal data point, comparing one or more of those dimensions, of the new primal data point, that have drifted most relative to an established threshold, with an importance table that comprises respective values for features of the new primal data point; and
when it is determined that the dimensions of the new primal data point with the most drift align with important features of a decoder, concluding that there is drift in the primal source vector.

2. The method as recited in claim 1, wherein the edge system comprises an instrumented system that comprises hardware and/or software and includes one or more sensors.

3. The method as recited in claim 1, wherein the new vector was created by the edge system.

4. The method as recited in claim 1, wherein a determination that there is drift in the primal source vector is made directly from the fused concatenated data.

5. The method as recited in claim 1, wherein the importance table comprises a list of decoders, including the decoder, and a respective importance value for specified features, including the specified features of the decoder, of each of the decoders.

6. The method as recited in claim 1, wherein the reduced vector is created by using an encoder to encode the primal source vector.

7. The method as recited in claim 1, wherein a message is created and transmitted that identifies which primal source(s) of the primal source vector are drifting.

8. The method as recited in claim 1, wherein concluding that there is drift in the primal source vector comprises concluding that one or more particular primal sources of the primal source vector are drifting.

9. The method as recited in claim 1, wherein only fused data is received from the edge system.

10. The method as recited in claim 1, wherein respective SHAP values indicate a respective importance of each of the features.

11. A non-transitory storage medium having stored therein instructions that are executable by one or more hardware processors to perform a method for detecting and identifying source data in fused data, the method comprising:
receiving, from an edge system, a new primal data point in a form of a reduced vector, the reduced vector comprising fused concatenated data obtained from a primal source vector;
comparing the new primal data point with a previously obtained data base of encoded datapoints;
when, as a result of the comparing, drift is detected in the new primal data point, comparing one or more of those dimensions, of the new primal data point, that have drifted most relative to an established threshold, with an importance table that comprises respective values for features of the new primal data point; and
when it is determined that the dimensions of the new primal data point with the most drift align with important features of a decoder, concluding that there is drift in the primal source vector.

12. The non-transitory storage medium as recited in claim 11, wherein the edge system comprises an instrumented system that comprises hardware and/or software and includes one or more sensors.

13. The non-transitory storage medium as recited in claim 11, wherein the new vector was created by the edge system.

14. The non-transitory storage medium as recited in claim 11, wherein a determination that there is drift in the primal source vector is made directly from the fused concatenated data.

15. The non-transitory storage medium as recited in claim 11, wherein the importance table comprises a list of decoders, including the decoder, and a respective importance value for specified features, including the specified features of the decoder, of each of the decoders.

16. The non-transitory storage medium as recited in claim 11, wherein the reduced vector is created by using an encoder to encode the primal source vector.

17. The non-transitory storage medium as recited in claim 11, wherein a message is created and transmitted that identifies which primal source(s) of the primal source vector are drifting.

18. The non-transitory storage medium as recited in claim 11, wherein concluding that there is drift in the primal source vector comprises concluding that one or more particular primal sources of the primal source vector are drifting.

19. The non-transitory storage medium as recited in claim 11, wherein only fused data is received from the edge system.

20. The non-transitory storage medium as recited in claim 11, wherein respective SHAP values indicate a respective importance of each of the features.
